(19) United States
(12) Patent Application Publication
(10) Pub. No.: US 2009/0087019 A1
(43) Pub. Date: Apr. 2, 2009

(54) Method fo rthe simultaneous deposition of a set of patterns on a substrate by a macrostamp

(75) Inventors: Jean-Christophe Cau, Toulouse (FR); Helene Lalo, Toulouse (FR); Jean-Pierre Peyrade, Ramonville Saint Agne (FR); Christophe Vieu, Auzeville (FR); Christophe Thibault, Toulouse (FR); Childerick Severac, Toulouse (FR)

Correspondence Address: PERMAN & GREEN, 425 POST ROAD, FAIRFIELD, CT, 06824, US

(73) Assignee: INNOPSYS, CARBONNE (FR)

(21) Appl. No.: 12/206,146

(22) Filed: Sep. 8, 2008

(30) Foreign Application Priority Data
Sep. 13, 2007 (FR) 0757543

(51) Int. Cl. G06K 9/00

(52) U.S. Cl. 382/100

(57) ABSTRACT

A stamp for depositing materials in the form of imprints on a surface of a substrate. The stamp includes a template and pins joined at one end to a first face of the template. The pins are arranged on the first face of the template so that the faces of all the pins joined to the template can be placed in contact virtually simultaneously on the surface of the substrate. The disclosed embodiments also relate to a method for fabricating the stamp and to a method for the virtually simultaneous deposition of a large number of imprints of identical or different materials on the surface of the substrate using the stamp, for an analysis.

### BACKGROUND

1. Field

The disclosed embodiments relate to the deposition of biological materials in the form of imprints on a substrate for an analysis. More particularly, the disclosed embodiments relate to a stamp, a method for fabricating said stamp and a deposition method for the virtually simultaneous transfer of a large number of imprints of identical or different biological materials, in particular imprints for which the biological materials are deposited, in a predefined arrangement.

2. Brief Description of Related Developments

In order to deposit molecules on a substrate for an analysis according to the predefined patterns, it is known to implement a method of transfer by microcontact. The transfer by microcontact is usually carried out using a stamp of appropriate dimensions, called microstamp, reproducing the patterns to be prepared with the molecule. Thus, in the case of millimeter-scale microstamps, the patterns reproduced are prepared on the nanometer scale.

A solution containing the molecule is initially deposited on the microstamp and is then transferred to the substrate by direct contact with the substrate. When the molecule is transferred to the substrate, the latter reproduces the patterns present on the microstamp, as a positive or as a negative, according to the technologies employed. This solution is described for example in U.S. Pat. No. 5,512,131.

In order to carry out analyses of a large number of molecules in a minimum of time, analytical devices, such as scanners for example, are normally used, suitable for scanning the substrate on the surface of which a large number of nanometer-scale patterns have been deposited, each corresponding to a molecule, in generally uniform arrangements, such as, for example, in the form of matrices of lines and columns.

When a large number of different molecules are to be deposited on a surface of the substrate, the transfer operation by microcontact is repeated as often as required. Intermediate operations of cleaning of the microstamps are required when said microstamps are used to deposit different molecules.

This solution therefore has limitations and is costly in terms of time.

### SUMMARY

The disclosed embodiments propose to solve these difficulties by means of a stamp for depositing materials on a surface of a substrate, said deposited materials being identical or not. Said stamp, called macrostamp, comprises:

a template, comprising a first face, called lower face,

pins joined to the template, each pin comprising:

an axis substantially perpendicular to the lower face of the template,

a first end joined to the lower face of the template,

a second end, called free end, opposite said first end along the axis, said free end having a face, substantially planar and locally parallel to a plane tangent to the lower face of the template for retaining a solution incorporating materials to be deposited,

said pins being arranged on the lower face of the template so that the faces of all the pins joined to the template can be placed in contact virtually simultaneously on the surface of the substrate.

Advantageously, to obtain a good compromise between the risks of pollution between the pins and the quality of said pins, the pins of the macrostamp are dimensioned so that a ratio

$$\frac{l}{d}$$

is between 1 and 2, preferably substantially equal to 1.5, where:

l is a length of the pin, between the face of the template and the face of the free end of said pin, and

d is a characteristic dimension of the cross section of said pins, in a plane perpendicular to the direction of the length l.

Advantageously, to obtain a compromise between the risks of pollution between the pins and the density of said pins, the pins of the macrostamp are dimensioned and arranged so that the ratios

$$\frac{d}{p} and \frac{d}{q}$$

are between 0.1 and 0.8, where p is a spacing between the pins along a line and q a spacing between the pins along a column.

In one embodiment, the template and the pins consist of at least one hardenable material, of the thermoplastic or elastomeric type, such as for example a polydimethylsiloxane (PDMS) or a polymethylmethacrylate (PMMA).

In an exemplary embodiment, a hardenable material is a mixture of at least two different polymers suitable for imparting specific mechanical and physical properties to the macrostamp.

Preferably, at least one face of the free ends of the pins comprises at least one pattern corresponding to the pattern in the form of which a material must be deposited on the substrate.

Preferably, the pattern may be a uniform surface, called spot, a periodic geometric figure, a complex geometric figure for diffracting light, or a combination of such patterns, and may be on a nanometer scale.

In one embodiment, the pins are arranged on the template so that each pin corresponds to an arrangement of wells of a well plate, for the simultaneous fitting of the pins into the wells.

The disclosed embodiments also relate to a method for fabricating the macrostamp which comprises the steps of:

positioning a mold on one face of a slide, said mold comprising penetrating recesses reproducing in dimensions and in arrangement a hollow shape corresponding to the dimensions and arrangement of the pins of the macrostamp, said recesses each terminating in an opening on a lower face of the mold, said positioning being obtained so that said lower face of said mold is in contact with the face of the slide,

filling the recesses of the mold with at least one hardenable material which, after hardening, constitutes the macrostamp,

extraction of the macrostamp from the mold.

Preferably, a uniform pressure is applied, sufficient to prevent a flow of at least one hardenable material between the mold and the slide during the step of filling sites of said mold.

When the method is implemented, the recesses of the mold are filled with the at least one hardenable material at the openings of each recess terminating on an upper face of the mold, opposite the lower face.

Preferably, at least one hardenable material is poured on the upper face of the mold, between the outer ledges, to form all or part of the template of the macrostamp.

The material used to prepare the mold is selected from a family of materials to which the at least one hardenable material of the macrostamp does not adhere, such as for example a polymer of tetrafluoroethylene or a polyurethane.

Advantageously, the recesses of the mold are prepared with a shape adapted to the stripping of the at least one material constituting the macrostamp.

In a particular embodiment, the method comprises a prior step of production of patterns, called negative patterns, on the face of the slide, so that the negative patterns represent a negative of the patterns to be produced on the pins of the macrostamp. Advantageously, the mold is positioned on the face of the slide so that each opening of the recesses of said mold surrounds a negative pattern.

The disclosed embodiments also relate to a method for the virtually simultaneous deposition of materials on a surface of a substrate using the macrostamp, the deposited materials being different or not. The deposition method comprises the steps of:

depositing solutions comprising the various materials on the faces of the pins of the macrostamp,

partial drying of the deposited solutions,

temporary application of the macrostamp to the surface of the substrate, so that the materials are deposited virtually simultaneously on the surface of the substrate while reproducing the shape of the imprints of the faces of the various pins.

In one embodiment of the method, the solutions are deposited by dipping the pins of the macrostamp in wells of a well plate.

Advantageously, a well of the well plate, having a depth H, is filled with a filling level n so that

$$H - l < n < H - l \frac{{S}_{pin}}{{S}_{well}} ,$$

where Sₚᵢₙ determines an area of the pin, and S_{well} an area of the well.

Advantageously, the same macrostamp may be applied several times to deposit materials on a surface of at least one substrate.

### BRIEF DESCRIPTION OF THE DRAWINGS

The detailed description of the disclosed embodiments is provided with reference to the figures which show:

FIG. 1, a perspective view of a macrostamp according to the disclosed embodiments,

FIG. 2, a view from below of a macrostamp according to the disclosed embodiments,

FIG. 3, a cross section of a macrostamp according to the disclosed embodiments,

FIG. 4, an illustration of the various steps of the method,

FIG. 5, an illustration of various patterns during the additional step of preparing patterns called reversed patterns,

FIG. 6, a perspective view of a macrostamp showing an arrangement of pins according to an arrangement of the wells of a well plate.

A macrostamp, for the virtually simultaneous deposition of several materials on a substrate, according to the disclosed embodiments, is defined as a set of indissociable elements comparable to microstamps, the macrostamp having dimensions at least one order of magnitude higher than the dimensions of the microstamps concerned. Thus in the case of millimeter-scale microstamps, the macrostamp has centimeter-scale dimensions.

The disclosed embodiments are described in the case of the deposition of materials on a substrate. The materials are for example:

biological materials such as cells and microorganisms such as bacteria,

chemical or biochemical materials such as molecules, for example silanes, biomolecules, such as oligonucleotides, deoxyribonucleic acid (DNA), plasmids, proteins, antibodies, oligosaccharides, polysaccharides.

### DETAILED DESCRIPTION OF THE DISCLOSED EMBODIMENTS

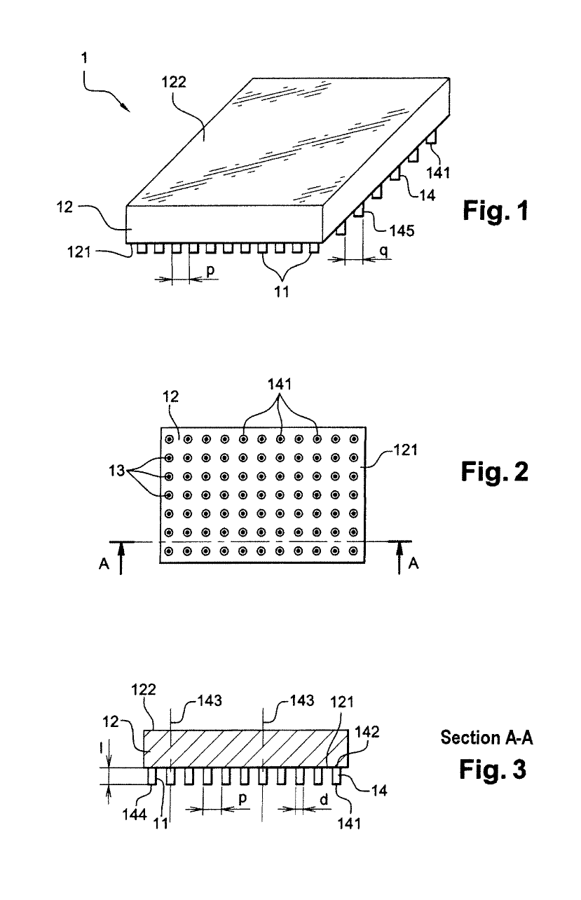

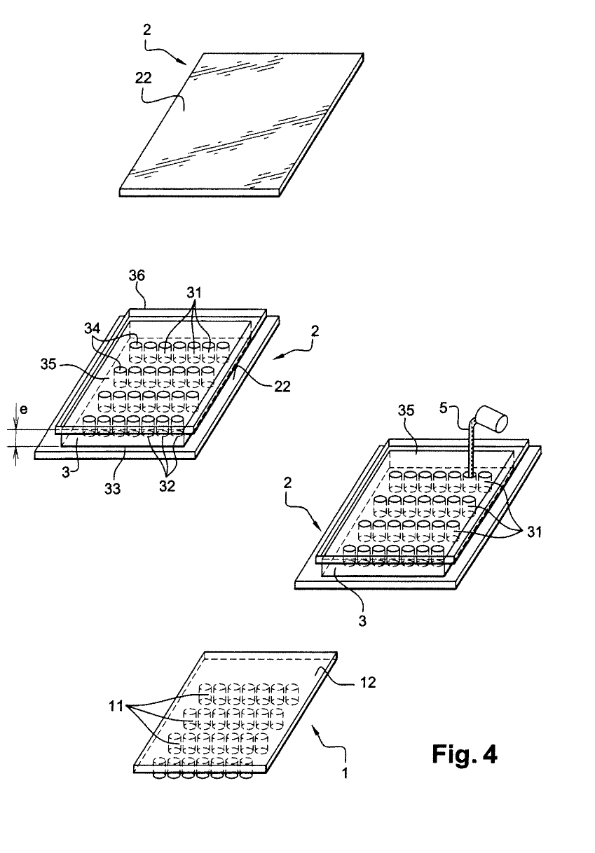

The macrostamp 1, as shown in FIGS. 1 to 3, comprises a template 12 and a set of microstamps 11. Preferably, the microstamps 11 are arranged in a regular arrangement, for example in a matrix of lines and columns, as generally observed for the arrangement of the wells in a well plate.

Each microstamp is prepared in the form of a pin 14, having an elongate shape, of which one of the ends 142 is joined to a face 121 of the template 12 and of which the other end, called the free end 144, on the side opposite the face 121 of the template 12, has a face 141 that is substantially planar and substantially parallel to the face 121 of the template 12. Advantageously, the face 141 comprises a pattern 13, in relief or recessed, corresponding to the pattern in the form of which a material must be deposited.

Advantageously, the faces 141 of the set of microstamps 11 are located in the same plane, substantially parallel to the face 121 of the template 12.

In another embodiment, each face 141 of a pin is substantially planar and locally parallel to a plane tangent to the lower face 121 of the template 12.

The pins 14, having an axis 143, are spaced from one another along a line by a spacing p or along a column by spacing q, have a length l between the face 121 of the template 12 and the face 141 of the free end 144 of said pin, and, in a plane perpendicular to the length direction, have a dimension d characteristic of the cross section of said pins.

Advantageously, the spacings p and q between the pins are substantially identical.

Advantageously, the pins have a cylindrical shape or a conical shape with a large base of the cylindrical cone joined to the face 121 of the template 12. Preferably, cylindrical pins have a circular cross section with diameter d, and conical pins have a circular cross section with diameter d, at the average cross section of the pins.

Advantageously, the pins are dimensioned so that a ratio

$$\frac{l}{d}$$

is between 1 and 2, preferably substantially about 1.5. The ratio

$$\frac{l}{d}$$

constitutes a compromise between the risks of pollution of the solution deposited on a microstamp by the solution of a neighboring microstamp and the quality of the pins. If the pins are long and thin, the risk of pollution by migration is reduced, but the preparation of the pins is more difficult and the pins may not be stiff enough to deposit the materials at the desired sites without mixing the solutions of different microstamps. If the pins are short and thick, their stiffness is satisfactory, but the risk of pollution by migration is high unless the pins are more widely spaced.

Advantageously, the pins are dimensioned and arranged so that the ratios

$$\frac{d}{p} and \frac{d}{q}$$

are between 0.1 and 0.8. The ratio

$$\frac{d}{p} ,$$

respectively

$$\frac{d}{q} ,$$

constitutes a compromise between the risks of pollution, for example by migration, whether molecular or by capillarity, and the density of the pins. The more widely the pins are spaced, the lower the risk of pollution, but on the other hand, the density of the pins decreases, militating against obtaining a high density of samples to be deposited on a substrate.

Advantageously, each microstamp 11 comprises, on its face 141, either a single pattern 13, such as for example a uniform surface, called spot, a periodic geometric figure such as a one-dimensional or two-dimensional grating, for example a line grating or a grid, or a complex geometric figure for diffracting light, or a plurality of identical patterns 13, such as for example a plurality of spots or a plurality of periodic or complex geometric figures capable of diffracting light. In the case of a millimeter-scale microstamp, the pattern is on a sub-millimeter or nanometer scale.

In an exemplary embodiment for a macrostamp, the macrostamp is prepared so that the pins are arranged in an arrangement of wells of a standard well plate having 1536 wells. The 1536 well standard well plate has a period between two wells, along the lines and columns, of substantially 2.25 mm, a well cross section of between 1.3 mm and 1.8 mm, and a well depth of between 4 and 5 mm. The centimeter-scale macrostamp comprises a set of millimeter-scale pins, having a circular cross section, spaced from one another along a line by a spacing p of substantially 2.25 mm and along a column by a spacing q of substantially 2.25 mm. The pins have a length l of between 1 mm and 2 mm, preferably 1.5 mm, and a dimension d of between 0.5 mm and 1.2 mm, preferably 1 mm.

The macrostamp 1 of the disclosed embodiments is advantageously prepared by a molding operation in a bottomless mold 3 previously fastened to one face 22 of a rigid slide 2.

In a first step of the method, the mold 3 is installed on the face 22 of the slide 2.

The mold 3 comprises a lower face 33 which, owing to the shape and material of the mold and to the holding means (not shown) on the face 22 of the slide 2, is such that said lower face 33 is in the most intimate possible contact with the face 22 of the slide 2.

The mold 3 used for the implementation of the method comprises a recess reproducing the volume of the macrostamp. Thus the mold 3 comprises recesses 31 corresponding to the pins 14 of the macrostamp. Each recess, penetrating the mold 3 between the lower face 33 and a face opposite the lower face 33, called upper face 35, has a hollow shape with the contours of an outer surface 145 of a pin 14.

Preferably, the recesses 31 are arranged to substantially match the arrangement of the wells of a well plate. Said recesses are spaced from one another by the spacing p along the lines and q along the columns.

The recesses 31 in the mold 3 terminate on either side of said mold via openings 34 on the upper face 35, opposite the lower face 33 of the mold, and via openings 32 on the lower face 33 of the mold, that is the face in contact with the face 22 of the slide 2 when the mold 3 is in place.

The mold 3 has a thickness e at the recesses 31 that is substantially equal to the desired length l of the pins 14 of the macrostamp 1.

Advantageously, the mold 3 comprises outer ledges 36 which determine all or part of a thickness of the template 12 of the macrostamp 1.

To permit the subsequent stripping of the pins 14 prepared by the method of the macrostamp 1, the mold 3 is advantageously made from a non-adhesive material, such as Teflon® or polyurethane.

The recesses 31 in the mold 3 may be prepared by any machining process suitable for the material used to prepare the mold.

Advantageously, the shape of the recesses 31 of the mold, corresponding to the hollow shape of the pins 14 of the macrostamp 1, is prepared so that the pins are readily strippable. In an exemplary shape, the recesses are cylindrical or conical with a large base of the cone located on the side of the upper face 34 of the mold 3.

During the implementation of the first step of the method, it is important for the contact obtained between the mold 3 and the face 22 of the slide 2 to be sufficient to obtain a tightness such that a material remains contained in the recesses 31 during a subsequent operation of filling the mold 3 and is not liable to flow between the mold 3 and the face 22 of the slide 2.

The tightness between the mold 3 and the face 22 of the slide 2 is obtained for example by applying a pressure to the mold 3.

One means for applying this pressure, for example, consists in placing support means (not shown) bearing on the ledges 36 of the mold 3 and at one or more points of a central zone of said mold, for example at points prepared without recesses for the pins in order to reserve zones for applying pressure.

In a second step of the method, one, two or more hardenable materials 5 are poured separately into the mold, said hardenable material or materials 5 thus molded constituting the macrostamp 1. In the context of the disclosed embodiments, hardenable material means a material which passes from a relatively fluid liquid state to a solid state, the change of state of said material being obtained for example by polymerization or crosslinking.

In a first exemplary embodiment, a hardenable material 5 is a polymer.

In a second exemplary embodiment, a hardenable material 5 is a mixture of at least two different polymers, suitable for imparting specific physical and mechanical properties to the macrostamp.

To carry out this second step, the at least one hardenable material 5 is poured on the upper face 35 of the mold 3 thereby filling the recesses 31, and also a continuous volume above the recesses 31, bounded by the ledges 36 of the mold 3, said volume forming the template 12 of the macrostamp 1.

In one embodiment, when two or more materials are poured, said at least two materials are poured in succession advantageously after an at least partial hardening of the material previously poured.

For example, a first material is poured into the mold to constitute the pins, then a second material, preferably stiffer, is poured, after hardening of the first material, to constitute the template.

The mold 3 is kept in position on the slide until the hardening of the at least one hardenable material 5 filling the mold 3.

The at least one hardenable material 5 must have characteristics adapted to the preparation of the macrostamp such as to be sufficiently fluid, in a first state, to fill the recesses of the mold 3 during the pouring operation, or to be sufficiently hard, in a second state, while preserving an elastomeric consistency for the microstamps.

Advantageously, the at least one hardenable material 5 is selected from a thermoplastic or elastomeric material, suitable for reproducing the shape of the recesses 31, such as for example polydimethylsiloxane (PDMS) or polymethylmethacrylate (PMMA).

In a third step of the method, after the hardening of the at least one hardenable material 5, said at least one hardenable material is extracted from the mold 3 and the macrostamp 1 thus prepared is released.

In one embodiment of this third step, the mold 3 being prepared so that the shape of the recesses of said mold is strippable, the macrostamp 1 is extracted for example by pulling at the ends of the template 12.

In another embodiment of this third step, the macrostamp 1 is extracted from the mold 3 using a gripping means. One means, for example, consists in inserting part of a gripping means (not shown) into the at least one hardenable material 5 constituting the template 12, at an upper face 122, opposite to the face 121, after the pouring of said at least one hardenable material into the mold 3 and before the hardening of said at least one hardenable material.

Advantageously, the gripping means allow easier handling of the macrostamp 1 prepared, during its application to the substrate.

By the choice of the materials used and the shape of the macrostamp, the stripping operation avoids damaging the macrostamp, the mold 3 or the slide 2, which are reusable for the application of the same method for the preparation of new macrostamps.

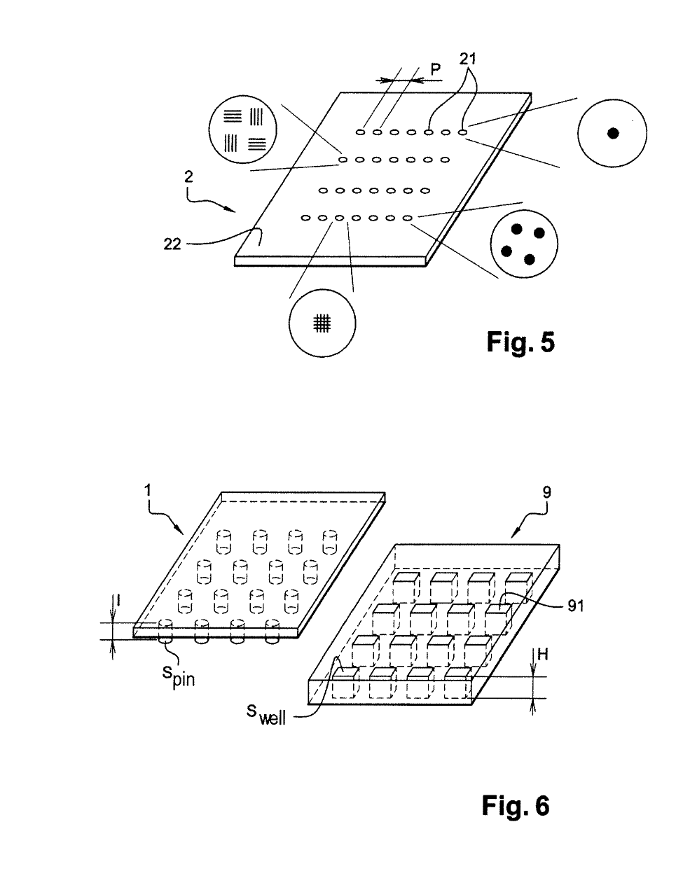

In a particular embodiment, the method comprises an additional step, prior to the step of installation of the mold 3 on the face 22 of the slide 2, of production of patterns, called negative patterns 21, on the face 22 of the slide 2, as shown in FIG. 5.

The patterns 21 to be reproduced on each face 141 of the free end 144 of the pins 14 must be prepared on the face 22 of the slide 2 at the locations of each pin.

Preferably, the slide 2 is a rigid plate, for example a silicon wafer.

Advantageously, the patterns 21 represent the negative of the patterns 13 to be prepared on the face 141 of the free end 144 of the pins 14 and are prepared by:

lithography, such as for example photolithography or electron lithography,

transfer of lithographed patterns by etching,

reactive-ion etching,

chemical etching.

When the mold is installed on the face 22 of the slide 2, the mold 3 is then positioned on the face 22 of said slide in such a way that each opening 32, owing to its dimensions which are substantially larger than those of a negative pattern 21, surrounds a negative pattern 21 of the slide 2.

The steps of the method described and the means for implementing the steps of the method serve to prepare a macrostamp 1 for the virtually simultaneous deposition of a large number of imprints on a substrate, said imprints comprising the materials to be analyzed.

Advantageously, a first step consists in depositing the solutions comprising the various materials to be analyzed on the faces 141 of the microstamps 11 of the macrostamp 1.

In one embodiment of this step, the solutions are deposited on the microstamps by means of a well plate.

In a first phase, the well plate is prepared. Each well of the well plate is filled with different solutions containing different materials to be analyzed.

In a second phase, the microstamps are virtually simultaneously dipped in the wells, so that the materials are deposited on the faces 141 of the microstamps 11, said faces comprising or not comprising a pattern 13.

Preferably, the spacings p and q between the microstamps are substantially equal to the spacings, along a line and along a column, between the wells of the well plates. In order to create a sufficient clearance for an easier insertion of the microstamps in their wells, the dimension d of a microstamp is such that it is lower than a width of the well.

To eliminate any risk of a solution overflowing from one well into another well, and hence of contamination, during said dipping operation, the volume of the pin 14 is preferably lower than the volume of the well and a well filling level n is determined according to the volume of the pin with regard to the volume of the well, so that if the filling level n is too low, the face 141 of the pin 14 is not dipped in said solution, and if it is too high, the solution overflows.

Thus when the volume of a pin 14 is defined by its length l and an area Sₚᵢₙ, and the volume of a well 91 of a well plate 9 is defined by a depth H and an area S_{well}, as shown in FIG. 6, the well is filled with the level n in such a way that:

$$H - l < n < H - l \frac{{S}_{pin}}{{S}_{well}} .$$

In a second step, the solutions comprising the materials are partially dried to reach a desired viscosity of the solutions for subsequent deposits. The partial drying time depends on the solution used.

In one embodiment of this step, the partial drying operation is carried out in the open.

In another embodiment of this step, to accelerate the drying of the solutions, the partial drying operation is carried out with moderate blowing on the faces 141 of the pins 11 of the macrostamp.

The blown substance may for example be an inert gas, such as nitrogen.

In a third step, the macrostamp 1 is applied temporarily to the surface of the substrate. During the application of the macrostamp, the materials are transferred to the substrate, reproducing the shape of the imprints of the face 141 of the various microstamps 11.

The substrate, for example a glass slide, may then be used to analyze the materials, for example using a specific scanner, which scans the substrate surface and records the response of each zone comprising materials to stimuli.

When the microstamps 11 comprise a pattern 13 on each face 141, the materials are deposited on the patterns of the microstamps and are then transferred to the surface of the substrate, reproducing the patterns 13 present on the microstamps.

When the microstamps 11 comprise a plurality of identical patterns 13 on their faces 141, the analysis of the materials deposited in the form of these patterns on the surface of the substrate serves to obtain a redundancy of the measurements and to have results with higher statistical reliability.

It is possible to use the macrostamp several times to deposit several series of patterns on various substrates or on the same substrate in order to increase the number of patterns deposited. During these multiple uses, the solution to be printed may be the same or different. In the latter case, it is necessary to clean the macrostamp between two uses.

When the macrostamp is not reusable, for example due to several uses that have given rise to damage of the macrostamp or of the patterns to be reproduced, the macrostamp is replaced without significant extra cost due to the possibility of reusing the mold and the slide to prepare a new stamp.

In an exemplary application, the macrostamp is prepared with patterns for the microstamps in the form of spots for the preparation of biochips, such as for example biochips corresponding to deposits of materials comprising deoxyribonucleic acid (DNA) or proteins, which are to be analyzed using a fluorescence scanner.

In another exemplary application, the macrostamp is prepared with patterns for the microstamps in the form of periodic geometric figures, such as gratings, for example one-dimensional or two-dimensional gratings, or complex geometric figures, for the preparation of biochips to be analyzed using a diffraction analysis device.

1. A stamp for depositing materials on a surface of a substrate, said deposited materials being identical or not, said stamp, called macrostamp, comprising:
a template, comprising a first face, called lower face,
pins joined to the template, each pin comprising:
an axis substantially perpendicular to the lower face of the template,
a first end joined to the lower face of the template,
a second end, called free end, opposite said first end along the axis, said free end having a face, substantially planar and locally parallel to a plane tangent to the lower face of the template for retaining a solution incorporating materials to be deposited,
said pins being arranged on the lower face of the template so that the faces of all the pins joined to the template can be placed in contact virtually simultaneously on the surface of the substrate, wherein at least one face of the free ends of the pins comprises at least one pattern corresponding to the pattern in the form of which a material must be deposited on the substrate, said pattern being a uniform surface, or spot, a periodic geometric pattern, a complex geometric pattern for diffracting light, or a combination of such patterns, and in that the pins have a millimeter scale and the pattern on the pins has a nanometer scale.

2. The macrostamp according to claim 1, in which a ratio
$$\frac{l}{d}$$
is between 1 and 2, preferably substantially equal to 1.5, ratio in which:
l is a length of the pin, between the face of the template and the face the free end of said pin,
d is a characteristic dimension of the cross section of said pins, in a plane perpendicular to the direction of the length l.

3. The macrostamp according to claim 1, in which the ratios
$$\frac{d}{p} and \frac{d}{q}$$
are between 0.1 and 0.8, ratios in which p is a spacing between the pins along a line and q a spacing along a column.

4. The macrostamp according to claim 1, in which the template and the pins consist of at least one hardenable material.

5. The macrostamp according to claim 4, in which a hardenable material is a polydimethylsiloxane (PDMS) or a polymethylmethacrylate (PMMA).

6. The macrostamp according to claim 4, in which at least one hardenable material is a mixture of at least two different polymers.

7. The macrostamp according to claim 1, in which the pins are arranged on the template so that each pin corresponds to an arrangement of wells of a well plate.

8. A method for fabricating a macrostamp according to claim 1, comprising:
positioning a mold on one face of a slide, said mold comprising penetrating recesses reproducing in dimensions and in arrangement a hollow shape corresponding to the dimensions and arrangement of the pins of the macrostamp, said recesses each terminating in an opening on a lower face of the mold, said positioning being obtained so that said lower face of said mold is in contact with the face of the slide,
filling the recesses of the mold with at least one hardenable material which, after hardening, constitutes the macrostamp,
extraction of the macrostamp from the mold.

9. The method according to claim 8, in which a uniform pressure is applied, sufficient to prevent a flow of at least one hardenable material between the mold and the slide during the step of filling sites of said mold.

10. The method according to claim 8, in which at least one hardenable material is poured on an upper face of the mold, on which the recesses terminate, between the outer ledges.

11. The method according to claim 8, in which the material used to prepare the mold is selected from a family of materials to which the at least one hardenable material of the macrostamp does not adhere.

12. The method according to claim 8, in which the recesses of the mold are prepared with a shape adapted to the stripping of the at least one hardenable material.

13. The method according to claim 8, comprising a prior step of production of patterns, called negative patterns, on the face of the slide, so that the negative patterns represent a negative of the patterns to be produced on the pins of the macrostamp.

14. The method according to claim 13, in which the mold is positioned on the face of the slide so that each opening of the recesses of said mold surrounds a negative pattern.

15. The method for the virtually simultaneous deposition of materials on a surface of a substrate using a macrostamp according to claim 1, said deposited materials being identical or not, comprising the steps of:
depositing solutions comprising the various materials on the faces of the pins of the macrostamp,
partial drying of the deposited solutions,
temporary application of the macrostamp to the surface of the substrate, so that the materials are deposited virtually simultaneously on the surface of the substrate while reproducing the shape of the imprints of the faces of the various pins.

16. The method according to claim 15, in which the solutions are deposited by dipping the pins of the macrostamp in wells of a well plate.

17. The method according to claim 16, in which a well of the well plate, having a depth H, is filled with a filling level n so that
$$H - l < n < H - l \frac{{S}_{pin}}{{S}_{well}} ,$$
in which:
Sₚᵢₙ determines an area of the pin,
S_{well} determines an area of the well.

18. The method for depositing materials on a surface of at least one substrate in which the same macrostamp is applied several times following the method according to claim 15.
